(19) United States
(12) Patent Application Publication
(10) Pub. No.: US 2004/0241481 A1
(43) Pub. Date: Dec. 2, 2004

(54) Multilayer film

(75) Inventors: Akihiro Ichige, Sodegaura-shi (JP); Koichi Yanase, Ichihara-shi (JP)

Correspondence Address: BIRCH STEWART KOLASCH & BIRCH, PO BOX 747, FALLS CHURCH, VA, 22040-0747, US

(73) Assignee: Sumitomo Chemical Co., Ltd.

(21) Appl. No.: 10/879,195

(22) Filed: Jun. 30, 2004

Related U.S. Application Data
(63) Continuation of application No. 09/442,416, filed on Dec. 1, 1999.

(30) Foreign Application Priority Data
Dec. 3, 1998 (JP) 10-344241

(51) Int. Cl. B32B 27/32

(52) U.S. Cl. 428/515; 428/523; 156/244.11

(57) ABSTRACT

There is provided a multilayer film comprising two outer layers and at least one inner layer interposed between the outer layers, wherein the multilayer film:

(i) is uniaxially oriented in a machine direction;

(ii) comprises an olefinic resin; and

(iii) has (a) a tear strength in a machine direction of not less than about 30 kg/cm, and (b) a tensile breaking point elongation in a machine direction of not more than about 150%.

### FIELD OF THE INVENTION

The present invention relates to a multilayer film. More specifically, the present invention relates to a multilayer film, which is superior in its self-tackiness and saw-toothed cutter-cutting property, and moreover has a property such that it can hardly be torn in a machine direction. The multilayer film of the present invention is especially suitable for a self-tacky wrapping film. In the specification of the present invention, the term “machine direction” means a direction in which a film runs at the time of production thereof.

### BACKGROUND OF THE INVENTION

The films having self-tackiness, in other words, self-tacky films, have found many applications as wrapping films to wrap foods per se or to seal foods put in a vessel hermetically. For example, when food wrapped with a self-tacky film is preserved in a refrigerator, loss of its moisture and flavor are prevented; also dust is prevented from adhering to the food; and moreover, the food's odor does not permeate into other foods kept in the refrigerator. And for example, when food wrapped with a self-tacky film is heat-treated in a microwave oven, its moisture can be prevented from evaporating. With respect to the wrapping film used in the latter case, it is desirable that the film has enough heat resistance for the foregoing heat-treatment as well as superior film-to-film and film-to-vessel tackiness.

As a self-tacky film, there are known polyvinylidene chloride-made films, polyvinyl chloride-made films and films made from a raw material comprising polyethylene as a main component. Of these, the polyvinylidene chloride-made films and polyvinyl chloride-made films have environmental problems due to the chlorine atoms contained in such films. In particular, polyvinyl chloride-made films have not only environmental problems but also toxic problems due to plasticizers contained therein. On the other hand, films made from a raw material comprising polyethylene as a main component do not have such environmental and toxic problems; however, such films are poor in their heat resistance. Incidentally, from an environmental point of view, it is desirable to use an olefinic resin as a raw material of self-tacky films.

In general, a self-tacky wrapping film is commercially available in a form such that a film having a thickness of from about 8 to 15 μm and a width of from about 20 to 45 cm is wound around a core material such as a paper pipe, and the resultant is put in a case such as a paper box made of a coated cardboard. When it is used, the self-tacky film is cut into a desired length with a saw-toothed cutter fitted on the case. The saw-toothed cutter has a simple blade made by punching an iron plate or coated cardboard having a thickness of, in general, about 0.2 mm in the form of a saw-tooth. The rigidity of the case supporting the saw-toothed cutter is as low as about 350 to 700 g/m².

When cutting the above-mentioned polyvinylidene chloride-made films with said saw-toothed cutter, such films have problems in that (i) a tear produced in the film on a part thereof spreads out, so that the film cannot be cut straight along the saw-toothed cutter, but is instead cut obliquely, and (ii) the films are easily torn in a machine direction.

When cutting the above-mentioned polyvinyl chloride-made films or films made from a raw material comprising polyethylene as a main component with said saw-toothed cutter, such films have a problem in that a large stretching of the films occurs. As a result, it is difficult to obtain a sharp cutting.

In this regard, the foregoing term “saw-toothed cutter-cutting property” means that the film can be cut straight and sharply along the saw-toothed cutter.

As self-tacky multilayer wrapping films which are free from halogen atoms such as a chlorine atom, there are proposed in JP-A 6-238848 a multilayer film obtained by laminating an ethylene-propylene-C₄₋₈ α-olefin terpolymer film on one or two (both) sides of a polycarbonate resin film, and in JP-A 6-122182 a multilayer film obtained by laminating an olefinic resin film on two (both) sides of a polyamide resin film with the aid of a composition (bonding agent) obtained by melt-blending an acid modified polyolefin with a polyamide resin. Each of the references referred to above is incorporated herein by reference in its entirety.

However, the multilayer films proposed in the noted JP-A's have the following problems:

(i) The films are not satisfactory in their self-tackiness, saw-toothed cutter-cutting property and flexibility.

(ii) The films are easily torn in a machine direction.

(iii) The films are not desirable from an environmental adaptability because reins other than olefinic resins are contained therein.

### SUMMARY OF THE INVENTION

Accordingly, an object of the present invention is to provide a multilayer film, which is superior in its self-tackiness and saw-toothed cutter-cutting property, and moreover has a property such that it can hardly be torn in a machine direction.

The present inventors have undertaken extensive studies to obtain a self-tacky multilayer wrapping film comprising olefinic resins. As a result, it has been found that a multilayer film comprising at least three layers, which is uniaxially oriented in a machine direction and has specific mechanical properties, can give a desired multilayer film. And thereby the present invention has been obtained.

The present invention provides a multilayer film comprising two outer layers and at least one inner layer interposed between the outer layers, wherein the multilayer film:

(i) is uniaxially oriented in a machine direction;

(ii) comprises an olefinic resin; and

(iii) has (a) a tear strength in a machine direction of not less than about 30 kg/cm, and (b) a tensile breaking point elongation in a machine direction of not more than about 150%.

The present invention also provides for a self-tacky wrapping film obtained from the above multilayer film, and still further provides a roll of such a self-tacky film in a dispenser comprising a cutter for cutting off a portion of the self-tacky film withdrawn from the roll and the dispenser. In such instances, the cutter typically has a cutting edge that is a serrated or a saw-toothed like cutting edge for cutting off a portion of the self-tacky wrapping film withdrawn from the roll and the dispenser, but is not limited thereto. Even more preferably, the dispenser comprising such a cutter is in the form of a carton comprising a paper or coated paper product (e.g-, cardboard, coated cardboard, and the like). However, the present inventive combinations of a roll of a self-tacky wrapping film and a dispenser therefor, are not limited to such preferred configurations; it only being required that the provided dispenser be capable of allowing one to (i) withdraw a portion of the self-tacky wrapping film from the roll and the dispenser, and (ii) cut the withdrawn portion of the self-tacky wrapping film utilizing said cutter.

Here, when the inner layer and at least one of the outer layers are laminated directly with each other (that is, the inner layer is placed adjacent to at least one of the outer layers), and the raw material forming the inner layer is the same as that forming the at least one outer layer, such layers are not generally distinguishable from each other. Therefore, in the present invention, in such a situation where the inner layer and at least one of the outer layers are laminated directly with each other (i.e., they form adjacent layers), the raw materials forming the inner layer are preferably not the same as those forming said at least one outer layer that is adjacent thereto. For completeness, it is noted that non-adjacent layers in the multilayered films of the present invention are not subject to any such provision.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### DETAILED DESCRIPTION OF THE INVENTION

The multilayer film of the present invention has a tear strength in a machine direction of not less than about 30 kg/cm, preferably from about 50 to 150 kg/cm. When the tear strength in a machine direction is less than 30 kg/cm, the multilayer film obtained may be easily torn in a machine direction. The tear strength in a machine direction is measured according to the method prescribed in JIS P8116.

The multilayer film of the present invention has a tensile breaking point elongation in a machine direction of not more than about 150%, preferably from about 5 to 100%, and more preferably from about 10 to 50%. When the tensile breaking point elongation in a machine direction exceeds about 150%, the saw-toothed cutter-cutting property may be deteriorated. The tensile breaking point elongation in a machine direction is measured according to the method prescribed in JIS K6781.

Further, the multilayer film of the present invention has a tear strength in a transverse direction of preferably not more than about 30 kg/cm, and more preferably from about 5 to 15 kg/cm. The tear strength in a transverse direction is measured according to the method prescribed in JIS P 8116. The multilayer film of the present invention has a property such that it can be torn almost straight in a transverse direction even without use of a saw-toothed cutter. The term “transverse direction” means a direction perpendicular to a machine direction.

Still further, the multilayer film of the present invention preferably has a ratio of the tear strength in a machine direction to that in a transverse direction (that is, tear strength in a machine direction/tear strength in a transverse direction), of not less than about 3, more preferably from about 5 to 20, and most preferably from about 8 to 15.

The term “olefinic resin” used in the present invention means a thermoplastic polymer having a content of a repeating unit derived from an α-olefin having 2 to 10 carbon atoms of not less than about 50% by weight. Said thermoplastic polymer contains, for example, a homopolymer of the olefin, a copolymer of at least two olefins mentioned above and a copolymer of at least one olefin mentioned above with at least one other monomer. Examples of the olefin are ethylene, propylene, butene-1, 4-methylpentene-1, hexene-1, octene-1 and decene-1, and examples of the other monomer are conjugated dienes such as butadiene and isoprene. Examples of the olefinic resin used in the present invention are an ethylene based resin, a propylene based resin, a butene based resin, a poly(4-methylpenetene-1) resin, a blend of these resins and their recycled resins.

The term “ethylene based resin” means a thermoplastic polymer having a content of a repeating unit derived from ethylene of not less than about 50% by weight. Said thermoplastic polymer contains, for example, a homopolymer of ethylene, a copolymer of ethylene with an α-olefin having 3 to 10 carbon atoms and a copolymer of ethylene with at least one other monomer. Examples of the olefin are propylene, butene-1, 4-methylpentene-1, hexene-1, octene-1 and decene-1. Examples of the other monomer are conjugated dienes such as butadiene and isoprene, non-conjugated dienes such as 1,4-pentadiene, acrylic acid, acrylic acid esters such as methyl acrylate and ethyl acrylate, methacrylic acid, methacrylic acid esters such as methyl methacrylate and ethyl methacrylate, and vinyl acetate.

Examples of the ethylene based resin are a low density polyethylene; a medium density polyethylene; a high density polyethylene; a copolymer of ethylene with an a α-olefin having 3 to 10 carbon atoms such as ethylene-propylene copolymer, ethylene-butene-1 copolymer, ethylene-4-methylpentene-1 copolymer, ethylene-hexene-1 copolymer, ethylene-octene-1 copolymer and ethylene-decene-1 copolymer; a copolymer of ethylene with a conjugated diene such as butadiene and isoprene; a copolymer of ethylene with a non-conjugated diene such as 1,4-pentadiene; a copolymer of ethylene with acrylic acid, methacrylic acid or vinyl acetate; and a resin obtained by modifying, for example, graft-modifying, the resin as mentioned above with, for example, an α,β-unsaturated carboxylic acid or its derivative such as acrylic acid and methyl acrylate or an alicyclic carboxylic acid or its derivative such as maleic anhydride.

The term “propylene based resin” means a thermoplastic polymer having a content of a repeating unit derived from propylene of not less than about 50% by weight. Said thermoplastic polymer contains, for example, a homopolymer of propylene, a copolymer of propylene with an α-olefin having 2 to 10 carbon atoms except propylene, and a copolymer of propylene with at least one other monomer. Examples of the olefin are ethylene, butene-1, 4-methylpentene-1, hexene-1, octene-1 and decene-1. Examples of the other monomer are conjugated dienes such as butadiene and isoprene.

Examples of the propylene based resin are a propylene homopolymer and a copolymer of propylene with at least one α-olefin having 2 to 10 carbon atoms except propylene, such as ethylene, butene-1 and hexene-1. The copolymer may be a random copolymer and a block copolymer of these, from a viewpoint of obtaining a moderate tackiness, a propylene based block copolymer, such as, for example, EXCELLEN KS37F3, a trade mark for the product of Sumitomo Chemical Co., LTD. is preferred.

Said preferred propylene based block copolymer can be produced by a process comprising the steps of:

(I) carrying out a first step of copolymerizing propylene with ethylene until a content of a component A, which is a propylene-ethylene copolymer having a content of a repeating unit derived from ethylene of from about 1.5 to 6.0% by weight, reaches from about 40 to 85% by weight based on the total weight of the component A and a below-defined component B; and

(II) carrying out, in the presence of the component A prepared in the step (I), a second step of copolymerizing propylene with ethylene until a content of the component B, which is a propylene-ethylene copolymer having a content of a repeating unit derived from ethylene of from about 7 to 17% by weight, reaches from about 15 to 60% by weight based on the total weight of the components A and B;

wherein an intrinsic viscosity, [η]_{B}, of the component B is from about 2 to 5 dl/g, and a ratio of [η]_{B} to an intrinsic viscosity, [η]_{A}, of the component A, i.e. [η]_{B}/[η]_{A}, is from about 0.5 to 1.8.

The term “butene based resin” means a thermoplastic polymer having a content of a repeating unit derived from butene of not less than about 50% by weight. Said thermoplastic polymer contains, for example, a homopolymer of butene and a copolymer of butene with at least one other monomer. The other monomer contains, for example, an α-olefin having 2 to 10 carbon atoms except butene. Examples of the α-olefin are ethylene, propylene, 4-methylpentene-1, hexene-1, octene-1 and decene-1. Besides the olefin, the other monomer further contains, for example, conjugated dienes such as butadiene and isoprene. An example of the butene based polymer is polybutene-1.

The olefinic resin used for the outer layers of the multilayer film in accordance with the present invention is not particularly limited in kind, and the foregoing propylene based resins are preferably used from a viewpoint of orientation processability as mentioned below.

The olefinic resin used for the inner layer of the multilayer film in accordance with the present invention is not particularly limited in kind. For example, the foregoing ethylene based resins or others having a flexibility higher than those used for the outer layers are preferably used from a viewpoint of obtaining a multilayer film having a property such that it can hardly be torn in a machine direction.

Examples of the ethylene based resins used for the inner layer of the multilayer film in accordance with the present invention are preferably a low density polyethylene; a copolymer of ethylene with an α-olefin having 3 to 10 carbon atoms such as, for example, propylene, butene-1, 4-methylpentene-1, hexene-1, octene-1 and decene-1; a copolymer of ethylene with vinyl acetate; a copolymer of ethylene with an acrylic acid ester such as methyl acrylate; a copolymer of ethylene with a methacrylic acid ester such as methyl methacrylate; and a blend of these resins.

From a viewpoint of heat resistance of the multilayer film in accordance with the present invention, it is desirable that at least one layer constituting the multilayer film preferably contains a high heat resistant resin such as, for example, propylene based resins and poly(4-methylpentene-1). In this case, the resulting multilayer film can exhibit a preferable heat resisting temperature of not lower than about 130° C., more preferably not lower than about 140° C. In the case where the heat resisting temperature is lower than about 130° C., the film may perforate when heat-treated in a microwave oven. The heat resisting temperature is measured according to the method prescribed in Notification No. 1027-of Tokyo Metropolis, “Indication on Quality of Wrapping Film”.

A thickness of the multilayer film in accordance with the present invention is usually from about 5 to 30 μm, and preferably from about 7 to 15 μm, and that of the inner layer occupies from about 20 to 90%, and preferably from about 30 to 80% of the thickness of the multilayer film.

Depending upon properties required for the multilayer film in accordance with the present invention, at least one additional inner layer may be interposed between the aforementioned two outer layers in addition to the aforementioned inner layer in a manner such that objects and effects of the present invention are by no means impaired. Raw materials for the additional inner layer are not particularly limited in kind.

The layered constructions of the multilayer films in accordance with the present invention are not particularly limited. Preferred examples of such layered constructions are a three-layer construction of “outer layer (1)/inner layer/outer layer (2)”; a five-layer construction of “outer layer (1)/additional inner layer (1)/inner layer/additional inner layer (2)/outer layer (2)”; and another five-layer construction of “outer layer (1)/inner layer (1)/additional inner layer/inner layer (2)/outer layer (2)”.

With respect to the above-mentioned layered constructions, raw materials forming the outer layers (1) and (2) may be the same or different from each other. Similarly, raw materials forming the inner layers (1) and (2) may be the same or different from each other; and raw materials forming the additional inner layers (1) and (2) may be the same or different from each other. Even so, raw materials forming any two adjacent layers in such constructions are preferably different from each other, such that the two adjacent layers are thereby distinguishable from each other.

For example, in the case of the above-mentioned five-layer construction of “outer layer (1)/additional inner layer (1)/inner layer/additional inner layer (2)/outer layer (2)”, the raw material forming the outer layer (1) may be the same as or different from that forming the inner layer, the additional inner layer (2) or the outer layer (2); and the raw material forming the outer layer (2) may be the same as or different from that forming the inner layer, the additional inner layer (1) or the outer layer (1) . Similarly, in the case of the above-mentioned five-layer construction of “outer layer (1)/inner layer (1)/additional inner layer/inner layer (2)/outer layer (2)”, the raw material forming the outer layer (1) may be the same as or different from that forming the additional inner layer, the inner layer (2) or the outer layer (2); and the raw material forming the outer layer (2) may be the same as or different from that forming the additional inner layer, the inner layer (1) or the outer layer (1).

If desired, the olefinic resin used in the present invention may be used in combination with various additives such as, for example, anti-oxidants, stabilizers, anti-static agents, tackifying agents and anti-fogging agents.

The multilayer film in accordance with the present invention can be produced by a process such that a non-oriented multilayer film obtained according to a known film production method such as a co-extrusion T-die method and co-extrusion inflation method is uniaxially oriented in a machine direction. Although a thickness of the non-oriented multilayer film is not particularly limited, preferred is from about 30 to 100 μm from a viewpoint of the thickness of the multilayer film in accordance with the present invention and an orientation ratio.

As a process for uniaxially orienting the foregoing non-oriented multilayer film in a machine direction, there can be enumerated a known process such as a roller stretching method wherein a roller stretching machine is used. The orientation ratio is preferably from about 2 to 10 times, more preferably from about 3 to 8 times, from a viewpoint of a saw-toothed cutter-cutting property of the multilayer film in accordance with the present invention. The “orientation ratio” in the roller stretching method is a ratio of a circumferential speed of a high speed roller to that of a low speed roller. During the uniaxial orientation of the non-oriented film in a machine direction, the film is usually decreased in its width. However, in the present invention, while such a decrease of film width is allowable, it is not madatory. If desired, the present multilayer film obtained through the uniaxial orientation may be cut into several films having a predetermined width.

An orientation temperature in the uniaxial orientation in a machine direction is not particularly limited and can be determined appropriately. It is usually from about 70 to 160° C., preferably from about 90 to 140° C. A heat set step may be additionally carried out after the orientation step. A temperature in the heat set step may be the same as or different from that in the orientation step. In-addition, in the heat set step, the film may be slacked in a machine direction.

According to the present invention, there can be provided a multilayer film, which is superior in its self-tackiness and saw-toothed cutter-cutting property and, moreover has a property such that it can hardly be torn in a machine direction. The olefinic resin used for the multilayer film in accordance with the present invention is a favorable resin from a viewpoint of an environmental adaptability. The multilayer film in accordance with the present invention can be used suitably as a wrapping film for home use or business purposes.

### EXAMPLE

The present invention is illustrated in more detail with reference to the following Examples, which are only illustrative, and are not limitative for the scope of the present invention.

Physical and thermal properties in Examples were obtained in the following manner.

1. Tear Strength

Respective tear strengths in a machine direction and a transverse direction of the film were measured according to the method prescribed in JIS P8116.

2. Tensile Breaking Point Elongation

It was measured in a machine direction of the film according to the method prescribed in JIS K6781.

3. Tensile Modulus (Young's Modulus)

It was measured in a machine direction of the film according to the method prescribed in ASTM D882 under the following conditions. The value is decreased with increase of the flexibility.

Shape of test piece: rectangular shape of 20 mm width×120 mm length.

Distance between clips: 50 mm.

Drawing speed: 5 mm/min.

4. Heat Resistance (Heat Resisting Temperature)

The heat resisting temperature was measured in the following manner with reference to Notification No. 1027 of Tokyo Metropolis, “Indication on Quality of Wrapping Film”;

(1) There are prepared test pieces of the film having a rectangular shape with a width of 3 cm and a length of 14 cm, and two pieces of cardboard having a width of 3 cm and a length of 2.5 cm, respectively.

(2) Said two pieces of cardboard are put on a 2.5 cm upper part and a 2.5 cm lower part of the test piece, respectively, and then they are fixed with the aid of an adhesive tape.

(3) The upper part of the test piece doubled with the cardboard is fixed to an instrument, and the lower part of the test piece doubled with the cardboard is loaded with 10 g.

(4) The resultant is rapidly placed in an air oven kept at a fixed temperature, followed by heating for 1 (one) hour, and then whether the film has been cut or not is examined.

(5) In the case where the test piece has not been cut even after the 1 hour-heating, the foregoing procedures are repeated with use of another test piece of the film at a testing temperature that is higher by 10° C. (nick temperature). On the other hand, when the test piece has been cut after 1 hour-heating, the foregoing procedures are repeated with use of another test piece of the film at a testing temperature that is lower by 10° C. (nick temperature). For completeness, a nick temperature as described in the aforementioned Notice No. 1027 of Tokyo Metropolis is 5 ° C.

(6) A maximum temperature at which the test piece has not been cut is referred to as “heat resisting temperature” of the test piece.

5. Saw-Toothed Cutter-Cutting Property

The saw-toothed cutter-cutting property of the film is evaluated using the film prepared by winding the film around a core material and then putting it in a case provided with a saw-toothed cutter. Said cutter is made by punching an iron board in the form of a saw tooth, and has a thickness of 0.2 mm. Said case is made of a coated cardboard having a rigidity of 500 g/m². The evaluation is conducted on the basis of the following criteria;

Superior: By laying the film on the saw-toothed cutter, followed by light drawing only, smooth cutting can be performed.

Inferior: The film can be cut but stretched, or the film cannot be cut because of stretching.

6. Maximum Peak Temperature of Fusion (Tm)

Using a differential scanning calorimeter manufactured by Perkin Elmer, a vessel, in which 10 mg of a test sample is placed, is kept at 220° C. for 5 minutes under nitrogen atmosphere to melt the test sample. Successively, the temperature is lowered from 220° C. to 40° C. at a rate of 5° C./min. Thereafter, the temperature is raised from 40° C. to 180° C. at a rate of 5° C./min., thereby obtaining a fusion endothermic curve. A peak temperature in the maximum peak of the fusion endothermic curve obtained is referred to as the “maximum peak temperature of fusion (Tm)” of the test sample. Incidentally, a melting point of indium (In), which was measured at a temperature raising rate of 5° C./min. using said differential scanning calorimeter, was found to be 156.60° C.

### Example 1

Using a resin composition of 100 parts by weight of a propylene based block copolymer, EXCELLEN KS37F3 (a trade mark for the product of Sumitomo Chemical Co., Ltd.), and 2 parts of an anti-fogging agent, STO-405 (a trade mark for the product of Marubishi Oil Chemical Co., Ltd., as a resin for the outer layers, and using an ethylene-vinyl acetate copolymer, EVATATE H2081 (a trade mark for the product of Sumitomo Chemical Co., Ltd.) as a resin for the inner layer, a multilayer film having a two kind-three layer constitution of outer layer/inner layer/outer layer was obtained with a three kind-three layer co-extrusion T die film molding machine manufactured by Modern Machinery.

With respect to the propylene based block copolymer used, Tm was 136° C.; MFR (Melt Flow Rate measured according to the method prescribed in JIS K7210) was 2.6 g/10 min.; an ethylene unit content in the propylene-ethylene copolymer component (component A) obtained in the above-mentioned step (I) was 3.0% by weight; a proportion of the component A to the sum of the components A and B was 70% by weight; an ethylene unit content in the propylene-ethylene copolymer component (component B) obtained in the above-mentioned step (II) was 12% by weight; a proportion of the component B to the sum of the components A and B was 30% by weight; an intrinsic viscosity, [η]_{B}, of the component B was 3.2 dl/g; and a ratio of the intrinsic viscosity of the component B to that [η]_{A}, of the component A, i.e. [η]_{B}/[η]_{A}, was 1.07.

With respect to the film formation, the resin for the outer layers was melt-kneaded at 240° C. using two extruders having a diameter of 40 mm and an L/D of 32, wherein L is a cylinder length of the extruder and D is a cylinder diameter thereof, and then was led to respective outer layer sides of a feed block. The resin for the inner layer was melt-kneaded at 240° C. using an extruder having a diameter of 50 mm and an L/D of 32, wherein L and D are as defined above, and then was led to the inner layer side of a feed block. These resins passed through the feed block were extruded through a 600 mm wide T die kept at 240° C., and then the extrudate was cooled and solidified through a chill roll kept at 20° C. and was wound around a paper pipe at a line speed of 30 m/min. to obtain a non-oriented multilayer film having a total thickness of 35 μm. A thickness ratio of respective layers in the resulting multilayer film, i.e. thickness of outer layer/thickness of inner layer/thickness of outer layer, was found to be 1/3/1.

The resulting non-oriented multilayer film was set on a roller stretching machine manufactured by Terao Seiki Co., Ltd., was passed through three pre-heating rolls of 110° C., two heat set rolls of 110° C. and one chill roll of 25° C. in this order, and then was wound up at a line speed of 10 m/min., thereby obtaining a multilayer film uniaxially oriented in a machine direction, which had a total thickness of 12 μm and a superior self-tackiness. A uniaxial orientation ratio was found to be 2.8 times on the basis of a ratio between the circumferential speed of the heat set roll (high speed roll) and that of the pre-heating roll (low speed roll) . The physical properties of the obtained multilayer film are as shown in Table 1.

### Example 2

Example 1 was repeated, except that an ethylene-butene-1 copolymer, EXCELLEN SPO, N0362 (a trade mark for the product of Sumitomo Chemical Co., Ltd.) was used as a resin for the inner layer, thereby obtaining a multilayer film uniaxially oriented in a machine direction, which had a total thickness of 12 μm and a superior self-tackiness. The physical properties of the obtained multilayer film are as shown in Table 1.

### Example 3

Using the same resin composition as used in Example 1 as a resin for the outer layers, and using an ethylene-hexene-1 copolymer, Sumikathene E, FV401 (a trade mark for the product of Sumitomo Chemical Co., Ltd., density=0.0902 g/cm³, Tm=111° C.) as a resin for the inner layer, and a propylene-ethylene copolymer, NOBLEN FS2011D (a trade mark for the product of Sumitomo Chemical Co., Ltd., ethylene unit content=0.4% by weight, Tm=158° C.) as a resin for the additional inner layer, a multilayer film having a three kind-five layer constitution of outer layer/additional inner layer/inner layer/additional inner layer/outer layer was obtained with a T die multifilm molding machine manufactured by Mitsubishi Heavy Industries, Ltd.

With respect to the film formation, the resin for the outer layers was melt-kneaded at 280° C. using an extruder having a diameter of 65 mm and an L/D of 29, and then was led to respective outer layer sides of a feed block. The resin for the inner layer was melt-kneaded at 280° C. using an extruder having a diameter of 65 mm and an L/D of 29, and then was led to the inner layer side of a feed block. The resin for the additional inner layer was melt-kneaded at 280° C. using an extruder having a diameter of 90 mm and an L/D of 33, and then was led to the additional inner layer side of a feed block. These resins passed through the feed block were extruded through a 1250 mm wide T die kept at 280° C., and then the extrudate was cooled and solidified through a chill roll kept at 20° C. and was wound around a paper pipe at a line speed of 100 m/min. to obtain a non-oriented multilayer film having a total thickness of 60 μm. A thickness ratio of respective layers in the resulting non-oriented multilayer film, i.e. thickness of outer layer/thickness of additional inner layer/thickness of inner layer/thickness of additional inner layer/thickness of outer layer, was found to be 1/1/3/1/1.

The resulting non-oriented multilayer film was treated in a manner similar to that of Example 1, provided that the temperature of three pre-heating rolls and two heat set rolls, the line speed and the orientation ratio were changed to 120° C. relating to all rolls, 30 m/min. and 5.3 times, respectively, thereby obtaining a multilayer film uniaxially oriented in a machine direction, which had a total thickness of 11 μm and a superior self-tackiness. The physical properties of the obtained multilayer film are as shown in Table 1.

TABLE 1

| Example | 1 | 2 | 3 |
|---|---|---|---|
| Tear strength in a | 95 | 59 | 107 |
| machine direction | | | |
| (kg/cm) | | | |
| Tear strength in a | 14 | 3 | 6 |
| transverse direction | | | |
| (kg/cm) | | | |
| Tensile breaking point | 110 | 110 | 20 |
| elongation in a machine | | | |
| direction (%) | | | |
| Tensile modulus | | | |
| (Mpa) | 167 | 186 | 843 |
| (kg/cm²) | 1700 | 1900 | 8600 |
| Heat resisting | 130 | 130 | 150 |
| temperature (° C.) | | | |
| Saw-toothed | Superior | Superior | Superior |
| cutter-cutting | | | |
| property | | | |

We claim:

1. A process for producing a multilayer film comprising the steps of:
(1) producing a non-oriented multilayer film comprising two outer layers and at least one inner layer interposed between the outer layers, and
(2) uniaxially orienting the non-oriented multilayer film in a machine direction at from 110 to 120° C.,
wherein (i) the outer layers contain a propylene based resin, and the inner layer contains an ethylene-vinyl acetate copolymer, an ethylene-butene-1 copolymer, an ethylene-hexene-1 copolymer or a propylene-ethylene copolymer, (ii) the inner layer has thickness of from 20 to 90% of the total thickness of the multilayer film, and (iii) the multilayer film has (a) a tear strength in a machine direction of not less than about 30 kg/cm, and (b) a tensile breaking point elongation in a machine direction of not more than about 150%.

2. The process for producing a multilayer film according to claim 1, wherein the multilayer film has a tear strength in a transverse direction of not higher than about 30 kg/cm.

3. The process for producing a multilayer film according to claim 1, wherein a ratio of a tear strength in a machine direction of the multilayer film to that in a transverse direction thereof is not less than about 3.

4. The process for producing a multilayer film according to claim 1, wherein the multilayer film has a three-layer construction of outer layer (1)/inner layer/outer layer (2).

5. The process for producing a multilayer film according to claim 1, wherein the multilayer film has a five-layer construction of outer layer (1)/additional inner layer (1)/inner layer/additional inner layer (2) /outer layer (2).

6. The process for producing a multilayer film according to claim 1, wherein the multilayer film has a five-layer construction of outer layer (1)/inner layer (1)/additional inner layer/inner layer (2)/outer layer (2).

7. The process for producing a multilayer film according to claim 1, wherein the multilayer film further has a heat resisting temperature being not lower than about 130° C.
